(19) United States
(12) Patent Application Publication
(10) Pub. No.: US 2007/0291592 A1
(43) Pub. Date: Dec. 20, 2007

(54) Street clock

(76) Inventor: James K. Heineman, Rock Island, IL (US)

Correspondence Address: LAW OFFICE OF JAY R. HAMILTON, PLC., 331 W. 3RD ST., NEW VENTURES CENTER SUITE 120, DAVENPORT, IA, 52801, US

(21) Appl. No.: 11/454,428

(22) Filed: Jun. 15, 2006

(51) Int. Cl. G04C 11/00

(52) U.S. Cl. 368/46

(57) ABSTRACT

A street clock comprising a master movement, at least one slave movement controlled by said master movement and communicating with said master movement via a controller conduit or via said controller conduit in conjunction with adjacent said slave movement(s). The street clock may have a plurality of clock faces, each face having hands operated by and mechanically engaged with either said master movement or one of said slave movement(s); a backlight mounted behind each of said faces for illuminating each of said faces; a battery cradle engaging a plurality of batteries for powering said master movement, said slave movement(s) and said backlights via a common electrical conduit. The street clock employs a housing enclosing said master movement, said slave movement(s), said backlight, at least a portion of said electrical conduit, at least a portion of said controller conduit and said clock faces.

### FIELD OF INVENTION

The invention relates to outdoor clocks. The embodiments shown and described herein are more particularly for use in pedestal or wall type street clocks.

### CROSS REFERENCE TO RELATED APPLICATIONS

None

### STATEMENT REGARDING FEDERALLY SPONSORED RESEARCH OR DEVELOPMENT

No federal funds were used to develop or create the invention disclosed and described in the patent application.

### REFERENCE TO SEQUENCE LISTING, A TABLE, OR A COMPUTER PROGRAM LISTING COMPACT DISK APPENDIX

Not Applicable

### BRIEF DESCRIPTION OF THE DRAWINGS

FIG. 1 shows a pedestal clock embodiment of the present invention.

FIG. 2 shows a detailed view of the clock face of the present invention.

FIG. 3 shows a cross sectional view of the housing in one embodiment of the present invention.

FIG. 4 shows a wall clock embodiment of the present invention.

FIG. 5 shows an internal perspective view of the present invention.

FIG. 6 shows a detailed view of the base of a pedestal clock embodiment of the present invention with the access door removed.

FIG. 7 shows a detailed view of the battery cradle and parallel circuitry in one embodiment of the present invention.

FIG. 8 is a cross-sectional view of a wall clock showing a battery cradle mounted in another embodiment.

FIG. 9A is a schematic illustrating the electrical system and master slave relationship with a quart master movement.

FIG. 9B is a schematic illustrating the electrical system and master slave relationship with a radio control master movement.

### DETAILED DESCRIPTION—LISTING OF ELEMENTS

| Element Description | Element Number |
|---|---|
| Clock Face | 1 |
| Housing | 2 |
| Base | 3 |
| Battery Cradle | 4 |
| Battery | 5 |
| Diode | 6 |
| Parallel Circuitry | 7 |
| Intentionally blank | 8 |
| Electrical Conduit | 9 |
| Master Movement | 10 |
| Slave Movement | 11 |
| Controller Conduit | 12 |
| Backlight Mounting Rod | 13 |
| Remote Time Adjuster | 14 |
| Antenna | 15 |
| Hands | 16 |
| Pedestal Clock | 17 |
| Button | 18 |
| Switch | 19 |
| Backlight | 20 |
| Battery Cradle Lid | 21 |
| Intentionally blank | 22 |
| Access Panel | 23 |
| Interior of Housing | 24 |
| Access Door | 25 |
| Wall Clock | 26 |
| Backlight Attachment Strap | 27 |
| Interior of Base | 28 |
| Alternating Current (AC) Electrical Conduit | 29 |

### DETAILED DESCRIPTION OF THE INVENTION

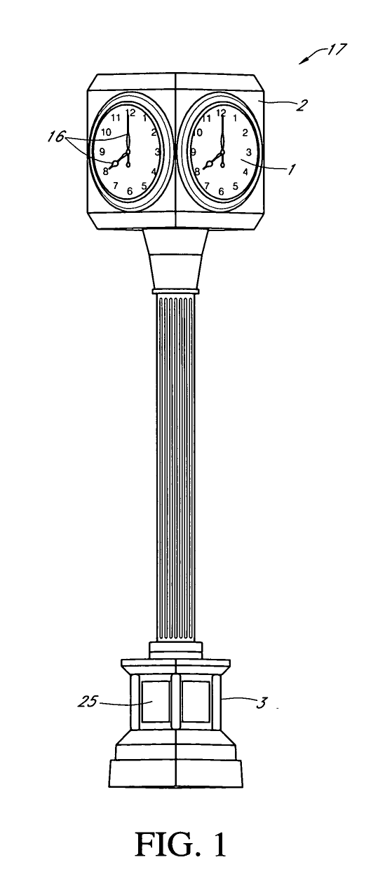

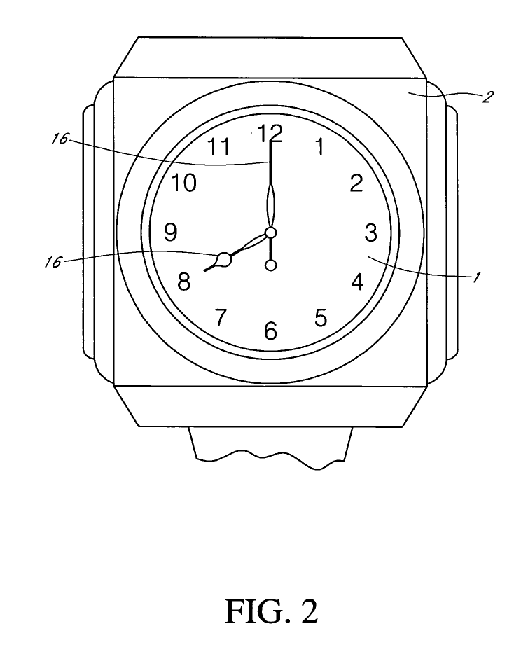

Referring now to the drawings, wherein like reference numerals designate identical or corresponding parts throughout the several views, FIG. 1 discloses and describes one embodiment of the present invention, showing a pedestal clock 17 with four clock faces 1 mounted in a housing 2. The pedestal clock 17 has a base 3 with an access door 25 that is typically connected to the base 3 via screws. Although not shown, a locking means may be employed to secure the access door 25. In one embodiment, the base 3 and housing 2 are constructed of commercial-grade aluminum because of its desirable corrosion resistance and density attributes, but the scope of the current invention is not limited by the materials of construction.

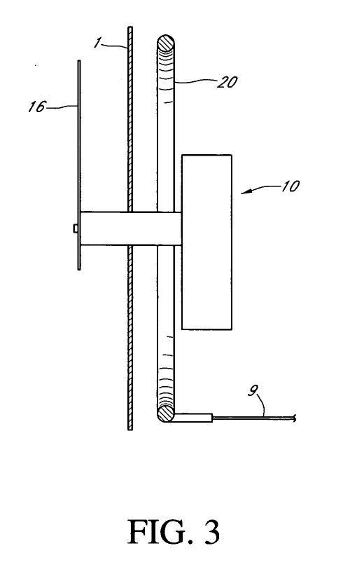

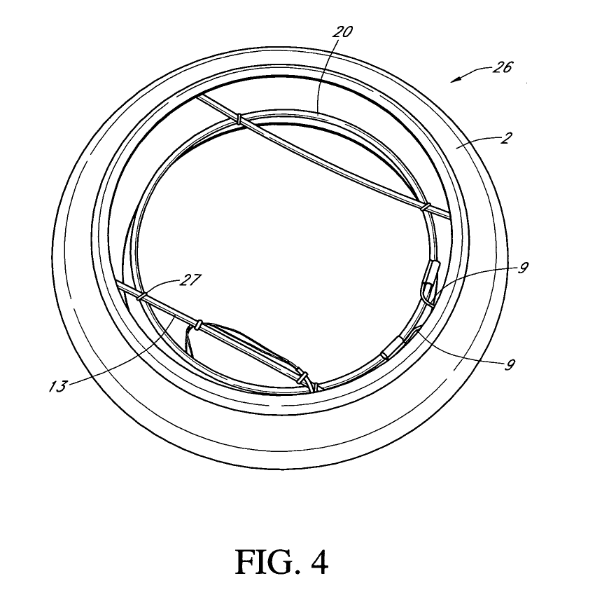

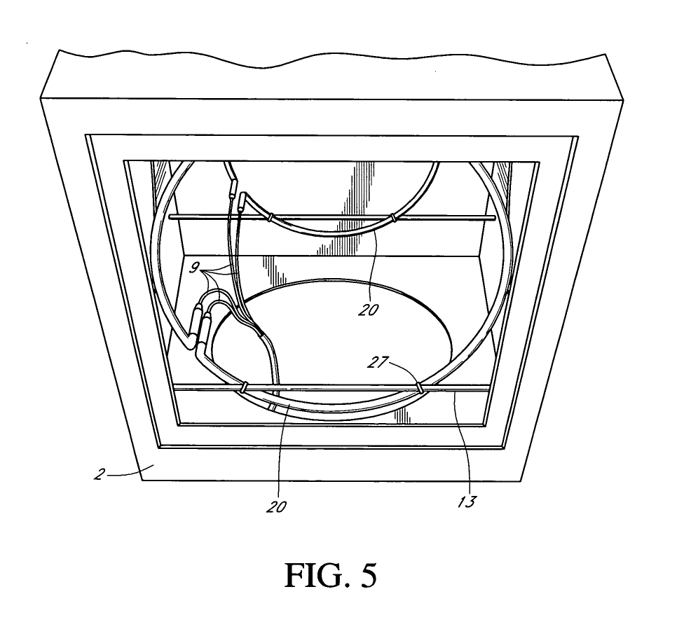

As illustrated in FIG. 1, the position of the hands 16 may be viewed at night by the placement of a backlight 20 behind the clock face 1. The distance between the backlight 20 and the clock face 1 may be varied for appearance and brightness. Typically the distance ranges from one-half inch to five inches. (See FIG. 4.) Methods and means to vary the distance are known to those skilled in the art and not described further herein. The backlight 20 is mounted in the housing 2 to a backlight mounting rod 13 in the housing 2 by a backlight attachment strap 27 as shown at FIG. 4. In the present embodiment, the backlight attachment strap 27 is composed of plastic, but other materials and means known to those skilled in the arts may be used to secure the backlight 20 to the backlight mounting rod 13. The color and lumen output of the backlight 20 may be specified for the desired characteristics according to the application of the clock face 1. The backlight 20 illuminates the translucent clock face 1 and accentuates the position of the opaque hands 16 as illustrated in FIG. 3. The backlight 20 may be sized to surround an area equal to or slightly less than the area of the clock face 1, or it may be of a similar shape as the clock face 1 with a smaller perimeter. The backlight 20 is constructed of an electrically powered continuous tubular neon type bulb so that it provides a continuous light source behind the clock face 1, thereby providing uniform light dissipation. The resulting view from the outside of the clock face 1 presents the clock face 1 at a uniform brightness, reducing areas of less intense light (shading) and more intense light (hot spots). The electrical power source for the backlight 20 may be any source known to those skilled in the art, such as 110 volt AC power, but in one embodiment, the backlight 20 is powered by lithium batteries 5 connected to the backlight 20 via electrical conduit 9. The clock face 1, hands 16 and the backlight 20 are enclosed in the housing 2 so that they are protected from fluctuations in weather and the elements associated with the outdoors.

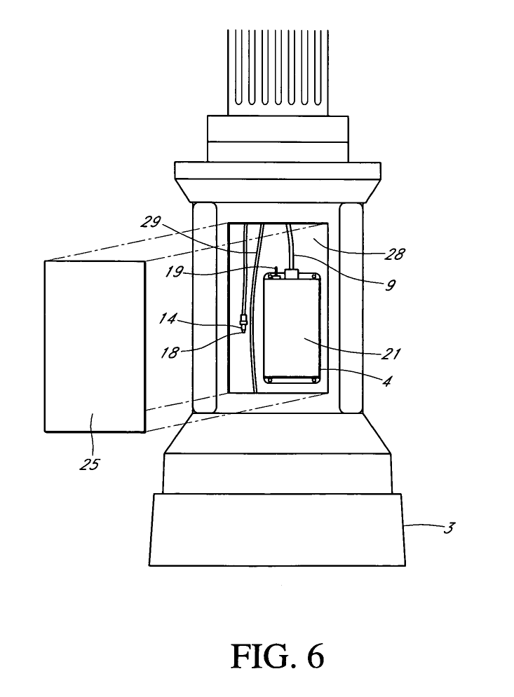

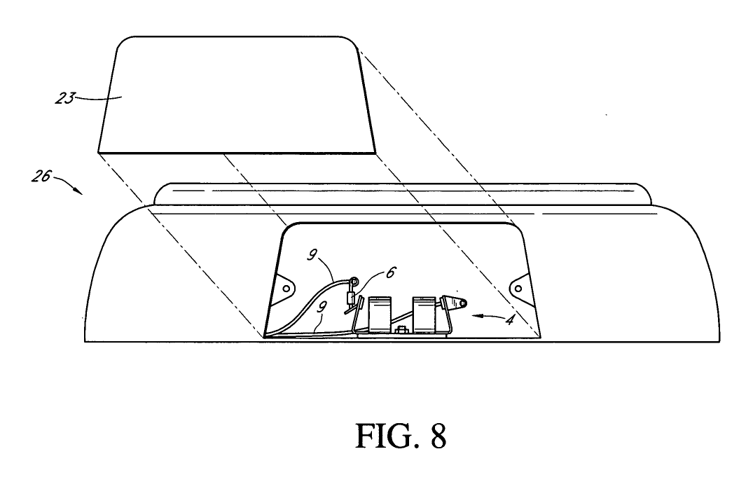

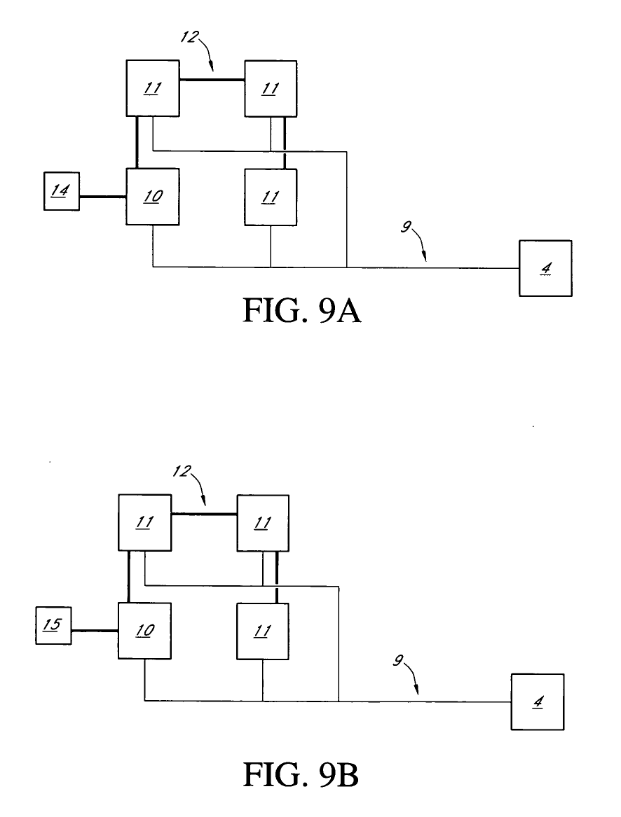

The hands 16 of each clock face 1 are mechanically coupled to either a master movement 10 or a slave movement 11, and the hands 16 are positioned by the respective movement 10, 11 coupled to the respective hands 16. That is to say, for each clock face 1 and set of hands 16, there must be one movement, either a master movement 10 or a slave movement 11. (See FIG. 8A.) The present invention employs one master movement 10 and may employ as few as no slave movements 11 (in a clock with one clock face 1), or as many as three slave movements 11 (in a clock with four clock faces 1), or any number in between (in a clock with two clock faces 1 or a clock with three clock faces 1). The present embodiment uses a microprocessor, not shown, to control the quartz master movement 10. It should be understood by those practiced in the arts that using a microprocessor is one means of controlling a master movement, as recited in the claims. As illustrated in FIG. 9A, both the master movement 10 and any slave movement(s) 11 are powered through an electrical conduit 9 from a battery cradle 4 (FIG. 8). The master movement 10 communicates with the slave movement(s) 11 through a controller conduit 12, and if more than one slave movement 11 is used, the master movement 10 communicates with the slave movements 11 not adjacent to the master movement 10 via the combination of controller conduit 12 and adjacent slave movements 11 (FIG. 9A). The master movement 10 directs the slave movements 11 to match the hand 16 position of the master movement 10 and in this way synchronizes the motion of the hands 16 on each clock face 1. If the master movement 10 is a quartz-type movement, the position of the hands 16 coupled to the master movement 10 (and subsequently the hands 16 coupled to any/all slave movement(s) 11) is adjusted by a remote time adjuster 14 in communication with the master movement 10 via controller conduit 12. The remote time adjuster 14 may be used to set the position of the hands 16 coupled to the master movement 10 through use of a logic controller in the master movement 10 which is currently available and known to those skilled in the art. By pressing and holding the button 18 on the remote time adjuster 14 for four seconds, one may accelerate the movement of the minute hand coupled to the master movement 10 and cause it to move forward in one-minute increments on the clock face 1 at approximately a rate of one increment per second. The minute hand will automatically resume normal operation after it has advanced sixty minutes. At any time during the accelerated movement of the minute hand, normal operation may be resumed by pressing and holding the button 18 for one second. The minute hand may also be adjusted by holding the button 18 for one second, which causes the minute hand to advance one one-minute increment on the clock face 1. This one second pressing of the button 18 and resulting one-minute increment movement of the minute hand may be repeated indefinitely until the desired time is displayed on the clock face 1. In this way, the time of all clock faces 1 in a single housing 2 may be set using the remote time adjuster 14. In one embodiment, the button 18 of the remote time adjuster 14 is situated in a place convenient for adjustment, but secure from tampering. FIG. 4 shows the button 18 positioned in the interior of the base 3 of a pedestal clock 17 so that the button 18 may easily be accessed through the access door 25, allowing for convenient adjustment of the hand 16 position, but also ensuring the button 18 is not tampered with since a locking means (not shown) may be employed on the access door 25 to limit accessibility. FIG. 6 shows the button 18 positioned in the interior of the housing of a wall clock 26, so that the button 18 may easily be accessed through the access panel 23, allowing for convenient adjustment of the hand 16 position, but also ensuring the button 18 is not tampered with because a locking means (not shown) may be employed on the access panel 23 to limit accessibility.

The master movement 10 may also be of the radio control type movement, also known to those skilled in the art, which continuously receives signals from the United States Naval Observatory atomic clock, located in Boulder, Colo., through a receiver antenna 15 which communicates with the master movement 10 through controller conduit 12. The transmissions received by the antenna 15 direct the master movement 10 to position the hands 16 coupled to the master movement 10 so that a clock employing this type of master movement 10 is set automatically and requires no input from the owner. A radio control type master movement 10 communicates with and controls slave movements 11 in the same manner as a quartz-type master movement 10, so that the hand 16 position of the hands 16 coupled to slave movements 11 do not need to be adjusted, but are controlled by the master movement 10. For optimal reception, the antenna 15 should be pointed towards Colorado. The antenna 15 may be mounted directly to the top of the master movement 10 inside the housing 2. When mounted inside the housing 2, the antenna 15 should be mounted on a caster mechanism so the direction of the antenna 15 may be adjusted for optimal reception. Alternatively, the antenna 15 may be mounted to the outside of the housing 2 for optimal reception, depending on the specific geographical location and application of the clock. If mounted on the outside of the housing 2, the antenna 15 may be colored and textured to match the exterior of the housing 2 so as not to detract from the aesthetic value of the clock. The master movement 10, all/any slave movement(s) 11 and at least a portion of the controller conduit 12 are enclosed in the housing 2 so that they are protected from fluctuations in weather and the elements associated with the outdoors. Additionally, in another embodiment, the button 18 for the remote time adjuster 14 and battery cradle 4 may also be enclosed in the housing 2 (shown in FIG. 6).

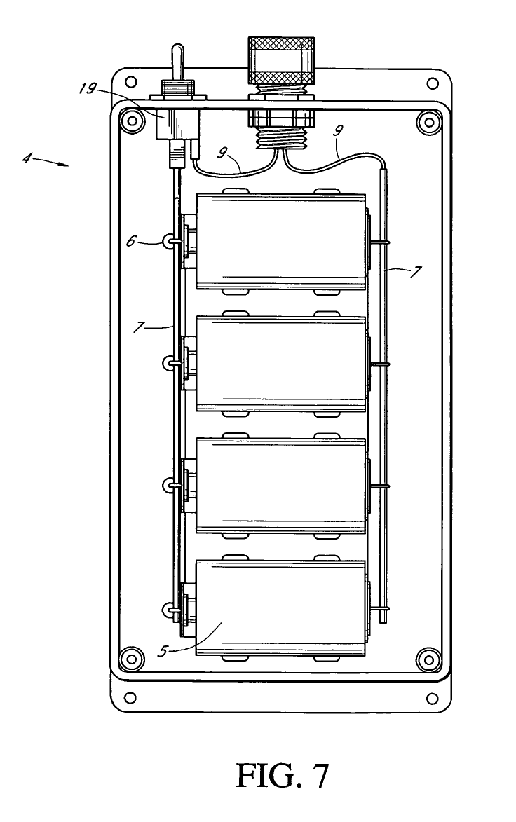

The battery cradle 4 is mounted within the interior of the base 28 and constructed to accept a plurality of batteries 5. In one embodiment shown in FIG. 8, the battery cradle 4 is fashioned to accept four 3.6 volt lithium batteries 5. (See also FIG. 7.) In one embodiment, the battery cradle 4 employs a common electrical switch 19 that does not allow electricity to flow through a common electrical conduit 9 to the master movement 10, slave movement(s) 11 or backlight 20 when the switch is in the “off” position, but does allow for current flow to these elements through a common electrical conduit 9 when in the “on” position. In another embodiment, only the master movement 10 and the slave movement(s) 11 are connected to the battery cradle 4 via the electrical conduit 9 and the backlight 20 is powered by alternative means, such as common 110 volt AC power routed through a separate electrical conduit 9. The electrical conduit 9 in the battery cradle 4 is constructed so that the electrical conduit 9 connects the batteries 5 in parallel, which ensures the total voltage available from the battery cradle 4 is equal to the total voltage available from one battery 5 (3.6 volts in one embodiment), but the current available from the battery cradle 4 is fourfold that of a single battery 5. Therefore, in one embodiment, the total amount of electrical energy available from the battery cradle 4 is four times the electrical energy available from a single battery 5. In this embodiment, the master movement 10 and each slave movement 11 share a common electrical conduit 9 for connection with the battery cradle 4. In this way, the battery cradle 4 ensures that the hands 16 of each clock face 1 will simultaneously stop when the batteries 5 in the battery cradle 4 are no longer able to supply the minimum amount of current required for the master movement 10 and slave movement(s) 11. The battery cradle 4 also ensures that when the hands 16 stop, all batteries 5 in the battery cradle 4 will be exhausted. Powering the master movement 10 and all slave movements 11 from a common electrical conduit 9 eliminates frivolous service requests caused by a scenario in which the hands 16 on one clock face 1 are moving while the hands 16 on another clock face 1 are stationary and the possibility of changing out batteries 5 that still have some current available. To ensure electricity does not flow from one battery 5 to another battery 5, but rather to the master movement 10, slave movements 11 and backlight 20, a diode 6 is mounted on the electrical conduit 9 adjacent each individual battery 5. This design alleviates any concern of one battery 5 charging another battery 5 through electrical conduit 9 adjacent each battery 5 if the first battery 5 has a larger charge than that of the second battery 5. In one embodiment, the battery cradle 4 is outfitted with a lid 21 to protect the batteries 5, diodes 6 and parallel circuitry 7 from outdoor conditions. The lid 21 may be secured to the main body of the battery cradle 4 by any means known to those skilled in the art, but in one embodiment, the battery cradle lid 21 is secured to the battery cradle with screws. In one embodiment, the internal elements of the battery cradle 4 are further protected from outdoor conditions by placing the entire battery cradle 4 in the base 3 so that it may be accessed from the access door 25. Such placement also adds to the convenience associated with changing the batteries 5 in the battery cradle 4 because of the physical elevation of the access door 25 and in most designs the base 3 is large enough to also enclose a spare set of a plurality of batteries 5. Since lithium batteries are of high value, in one embodiment some type of locking means, such as a padlock (not shown) may be employed to lock the access door 25 to the base 3 and avoid unwanted access to the base 3 via the access door 25. In another embodiment, the battery cradle 4 is placed in the housing 2 for easy access through the access panel 23. The access panel may also incorporate a locking means (not shown) similar to the locking means used with an access door 25 in a different embodiment.

It should be noted that the present invention is not limited to the specific embodiments pictured and described herein, but is intended to apply to all wall, pedestal or otherwise mounted outdoor clocks powered by means of batteries employing from one to three clock faces 1. Modifications and alterations from the described embodiments will occur to those skilled in the art without departure from the spirit and scope of the present invention.

What is claimed is:

1) A street clock comprising:
a. a master movement;
b. a first slave movement in communication with said master movement through a controller conduit, said master movement controlling said slave movement;
c. a first clock face having a first and second hand, said first and second hands controlled by said master movement and having a first backlight mounted behind said first clock face for illuminating said first clock face;
d. a second clock face having a first and second hand, said first and second hands of said second clock face controlled by said first slave movement and having a second backlight mounted behind said second clock face for illuminating said second clock face;
e. a battery cradle engaging a plurality of batteries for powering said master movement, said first slave movement and said first and second backlights through a common electrical conduit;
f. a housing enclosing said master movement, said first slave movement, said first and second backlights, at least a portion of said electrical conduit, at least a portion of said controller conduit and said first and second clock faces; and,
g. a remote time adjuster for adjusting said master movement communicating with said master movement via said controller conduit.

2) The street clock as set forth in claim 1 wherein the street clock is further defined as a pedestal clock, said pedestal clock having a base for attachment of said pedestal clock to a desired location, said base having an access door to access an interior of said base, said access door having a locking means to lock said access door to said base.

3) The street clock as set forth in claim 2 wherein said battery cradle and said remote time adjuster are enclosed in said interior of said base and accessible through said access door.

4) The street clock as set forth in claim 1 wherein a diode is electrically connected between each of said batteries and said electrical conduit preventing any of said batteries from drawing electricity from any other said battery through said electrical conduit.

5) The street clock as set forth in claim 4 wherein said batteries are further defined as lithium batteries.

6) The street clock as set forth in claim 5 wherein said battery cradle is further defined to hold four of said batteries.

7) The street clock as set forth in claim 1 wherein said backlights are further defined as tubular neon type bulbs sized and shaped to follow the perimeter of the clock face.

8) The street clock as set forth in claim 6 wherein said backlights are shaped to emulate the shape of the clock face and sized not to exceed the area of said clock face.

9) The street clock as set forth in claim 1 having a third and fourth clock face, said third clock face having a first and second hand, said first and second hands of said third clock face controlled by a second slave movement and having a third backlight mounted behind said third clock face for illuminating said third clock face, said fourth clock face having a first and second hand, said first and second hands of said fourth clock face controlled by a third slave movement and having a fourth backlight mounted behind said fourth clock face for illuminating said fourth clock face and wherein said second slave movement communicates only with said first slave movement and said third slave movement communicates only with said second slave movement.

10) The street clock as set forth in claim 1 wherein said master movement is further defined as a quartz movement.

11) The street clock as set forth in claim 9 wherein said master movement is further defined as a quartz movement.

12) The street clock as set forth in claim 1 wherein said master movement is further defined as a radio control movement designed to receive signals from the United States Naval Observatory atomic clock in Colorado through an antenna, said antenna communicating with said master movement via said controller conduit, said antenna mounted inside said housing.

13) The street clock as set forth in claim 9 wherein said master movement is further defined as a radio control movement designed to receive signals from the United States Naval Observatory atomic clock in Colorado through an antenna, said antenna communicating with said master movement via said controller conduit, said antenna mounted inside said housing.

14) The street clock as set forth in claim 13 wherein said batteries are further defined as lithium batteries.

15) The street clock as set forth in claim 14 wherein said battery cradle is further defined to hold four of said batteries.

16) The street clock as set forth in claim 13 wherein said backlight is powered via an external 110 volt alternating current power source.

17) The street clock as set forth in claim 1 wherein said battery cradle electrically engages said batteries in parallel.

18) The street clock as set forth in claim 16 wherein said battery cradle includes a lid impermeable to the elements for securement to said battery cradle.

19) The street clock as set forth in claim 1 wherein said lid is secured to said battery cradle by a securement means selected from the group consisting of screws, slots, adhesive materials, Velcro, bolts, clamps, magnets, clips, cords, wires and combinations thereof.

20) The street clock as set forth in claim 1 having a third clock face, said third clock face having a first and second hand, said first and second hands of said third clock face controlled by a second slave movement and having a third backlight mounted behind said third clock face for illuminating said third clock face and wherein said second slave movement communicates only with said first slave movement.

21) The street clock as set forth in claim 1 wherein said housing is constructed of aluminum.

22) The street clock as set forth in claim 21 wherein said battery cradle and said remote time adjuster are situated inside said housing and accessible via said access panel.

23) The street clock as set forth in claim 22 wherein said access panel incorporates a locking means.

24) A street clock comprising:
a. a master movement;
b. a clock face having a first and second hand, said first and second hands controlled by said master movement and wherein a backlight is mounted behind said clock face for illuminating said clock face;
c. a battery cradle engaging a plurality of batteries for powering said master movement and said backlight through a common electrical conduit wherein a diode is electrically connected between each of said batteries and said common electrical conduit preventing any of said batteries from drawing electricity from any other said battery through said common electrical conduit;
d. a controller conduit in communication with a remote time adjuster for adjusting said master movement;
e. a housing enclosing said master movement, said backlight, said electrical conduit, and said clock faces.

25) The street clock as set forth in claim 24 having a second clock face, said second clock face having a first and second hand, said first and second hands of said second clock face controlled by a slave movement and having a second backlight mounted behind said second clock face for illuminating said second clock face and wherein said slave movement communicates only with said master movement.

26) The street clock as set forth in claim 24 wherein said hands are constructed so as to be opaque and the clock face is constructed so as to be translucent.

27) The street clock as set forth in claim 26 wherein said battery cradle and said remote time adjuster are situated inside said housing and accessible via said access panel.
